(19) United States
(12) Patent Application Publication
(10) Pub. No.: US 2026/0080474 A1
(43) Pub. Date: Mar. 19, 2026

(54) Credit and Debit Card Investment System

(71) Applicant: William Todd Lassiter, Chapel Hill, NC (US)

(72) Inventor: William Todd Lassiter, Chapel Hill, NC (US)

(21) Appl. No.: 18/887,284

(22) Filed: Sep. 17, 2024

(51) Int. Cl. G06Q 40/06; G06Q 20/10

(52) U.S. Cl. CPC G06Q 40/06; G06Q 20/10

(57) ABSTRACT

A system which allows credit or debit transactions to round up to a designated amount for investments. Cash back rewards, or a dollar amount from debit and credit card transactions are routed to the accumulating account, and one time or recurring debit card transfers to the accumulating investment account. The round up sum is then used to invest in precious metals, stocks, bonds, crypto, ETFs and the like.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a system using bank cards (credit and debit) to aid investments. In particular, it relates to a system where credit card issuers have a system to aid credit card holders'investment saving.

### Description of Related Art

The investments in precious metals such as gold and silver occur with various methods of accomplishing an investment in the precious metal. This is also true with other types of investments for example stocks, bonds, ETFs, crypto and the like. Frequently the biggest problem with such investments is their high cost and the need to save money to make a purchase. Issuers of bank cards have ways of using the bank card to make payments on investments but not to save up for a purchase of an investment.

It's clear that a system of savings that benefits both the bank card issuer and the bank card user would be useful for both the bank card issuer and the bank card holder. The bank card holder would have a new service to offer and the card holder would have a new way to save for an investment.

### BRIEF SUMMARY OF THE INVENTION

The present invention relates to a system for accumulating funds by a bank card user to purchase an investment such as precious metals, stocks, bonds, ETFs, crypto and the like. This is accomplished by the issuing bank card having the ability to round up the sum charged on the bank card and that sum held until there is enough saved money to make a precious metal purchase.

Accordingly, in one embodiment, there is an issued bank card from an issuing bank that aids in saving for investing for a bank card user comprising:
a) an issued bank card feature that allows the bank card user to round up the sum over the actual charge placed on the issued bank card;
b) an issued bank card account for accumulating the round up sum; and
c) a system for sending the accumulated round up sum to an investment seller.

### DETAILED DESCRIPTION OF THE INVENTION

While this invention is susceptible to embodiment in many different forms, there is shown in the drawings, if any, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. To the extent such publication may set out definitions of a term that conflict with the explicit or implicit definition of the present disclosure, the definition of the present disclosure controls.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “issued bank card” refers to a credit or debit card used for charging purchases by a user. The card is issued by a bank who lends money or debits the user account to pay for card charges. This issued bank card has a feature where the user can indicate that he wishes to round up the purchase to a specific amount or percent. The extra money is placed in an account until it accumulates enough money for a desired precious metal purchase or other investment.

As used herein, the term “issuing bank” refers to a bank or other financial institution responsible for issuing a credit or debit card. The issuing bank is responsible for payments, handling transactions, and in the case of this invention, allows a round up sum added to each purchase or transaction.

As used herein, the term “saving for investing” refers to a round up sum being saved so that it can be used in a transaction to purchase an investment. This purchase can be through the issuing back or wherein the issuing bank transfers the round up sum to a separate place for investing.

As used herein, the term “bank card user” refers to the person to whom the credit or debit card is issued to. The bank card user will determine the round up sum. This can be done per transaction or a general round up of the same amount or percent of each transaction sum.

As used herein, the term “round up sum” refers to the bank card user designating to the issuing bank an amount to be added to each purchase and set aside investment for purchases. It can be a fixed amount, an amount to the nearest dollar, a percentage of the charge, the user can designate a preference for each transaction, and the like. In one embodiment, a bank card rewards program sum can be the round up sum.

As used herein, the term “actual charge” refers to the debit amount initially added to the account of the bank card user.

As used herein, the term “issued bank card account” refers to the bank card user's transactions and the rounded up sum including payment of debt and investing the round up sum in a precious metal or the like.

As used herein, the term “sending the accumulated round up sum” refers to the issuing bank accumulating all the round up sums from the card used by the bank card user. Once accumulated the sum is sent, it can be used in purchasing or investing in precious metals or the like.

As used herein, the term “investments” refers to any investment such as a precious metal, stocks, bonds, crypto, ETFs and the like.

As used herein, the term “fee for handling” refers to the issuing bank charge fee for the transaction, but also could be just a part of the service the issuing bank gives the card holder.

As used herein, the term “ETF” refers to Exchange Traded Funds.

In an additional embodiment where the bank card has a rewards program, the rewards can be used as a round up amount. In another embodiment, a one time amount can be the round up amount.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. An issued bank card from an issuing bank that aids in saving for investing for a bank card user comprising:
a) an issued bank card feature that allows the bank card user to round up the sum over the actual charge placed on the issued bank card;
b) an issued bank card account for accumulating the round up sum; and
c) a system for sending the accumulated round up sum to an investment seller.

2. The issued bank card according to claim 1 wherein the investment is a precious metal selected from the group of silver and gold.

3. The issued bank card according to claim 1 which further comprises the issuing bank charging the bank card user a fee for handling the round up sum.

4. The issued bank card according to claim 1 wherein the round up amount is money from the issuing bank cash back rewards program.

5. The issued bank card according to claim 1 wherein the round up amount is a one time payment.

6. The issued bank card according to claim 1 wherein the investment is selected from the group consisting of precious metals, stocks, bonds, ETFs and crypto.
